(19) United States
(12) Patent Application Publication
(10) Pub. No.: US 2005/0256700 A1
(43) Pub. Date: Nov. 17, 2005

(54) Natural language question answering system and method utilizing a logic prover

(76) Inventors: Dan I. Moldovan, Dallas, TX (US); Christine R. Clark, Dallas, TX (US)

Correspondence Address: Raffi Gostanian, Jr.;Jackson Walker L.L.P., Suite 600, 2435 North Central Expressway, Richardson, TX, 75080, US

(21) Appl. No.: 10/843,178

(22) Filed: May 11, 2004

(51) Int. Cl. G06F 17/27

(52) U.S. Cl. 704/9

(57) ABSTRACT

A natural language question answering system and method comprises receiving a question logic form, at least one answer logic form, and extended lexical information by a first module, outputting lexical chains to a second module, and utilizing axioms by the second module.

### CROSS REFERENCE TO RELATED APPLICATIONS

The present invention is related to copending patent application entitled, “NATURAL LANGUAGE QUESTION ANSWERING SYSTEM AND METHOD UTILIZING ONTOLOGIES,” filed on even date herewith, May 11, 2004, is commonly assigned, and is incorporated by reference herein.

### BACKGROUND OF THE INVENTION

The present invention is related to natural language processing, and, more specifically to a natural language question answering system and method utilizing a logic prover.

Automatic Natural Language Processing (NLP) for question answering has made impressive strides in recent years due to significant advances in the techniques and technology. Nevertheless, in order to produce precise, highly accurate responses to input user queries, significant challenges remain. Some of these challenges include bridging the gap between question and answer words, pinpointing exact answers, accounting for syntactic and semantic word roles, producing accurate answer rankings and justifications, as well as providing deeper syntactic and semantic understanding of natural language text.

The present invention overcomes these challenges by providing an efficient, highly effective technique for text understanding that allows the question answering system of the present invention to automatically reason about and justify answer candidates based on statically and dynamically generated world knowledge. By allowing a machine to automatically reason over and draw inferences about natural language text, the present invention is able to produce answers that are more precise, more accurate and more reliably ranked, complete with justifications and confidence scores.

### SUMMARY OF THE INVENTION

The present invention comprises a natural language question answering system and method utilizing a logic prover. In one embodiment, a method for natural language question answering, comprises receiving a question logic form, at least one answer logic form, and extended lexical information by a first module; outputting lexical chains to a second module; and utilizing axioms by the second module.

In another embodiment, a computer readable medium comprises instructions for receiving a question logic form based on a natural language user input query for information, at least one answer logic form, and extended lexical information by a first module; outputting lexical chains related to the extended lexical information to a second module; and utilizing axioms based on at least one of: the received lexical chains, existing axioms, and automatically created axioms, by the second module.

In a further embodiment, a method for natural language question answering, comprises receiving a user input query; receiving ranked answers related to the query; calculating a justification of the ranked answers; calculating a confidence of the ranked answers based on the justification; and outputting re-ranked answers based on the confidence.

In yet another embodiment, a method for ranking answers to a natural language query, comprises receiving natural language information at a first module (132); outputting logic forms to a second module and to a third module (138, 142); receiving lexical chains and axioms based on extended lexical information at the second module; receiving selected ones of the axioms and other axioms at the third module (142); determining whether at least one of the natural language information is sufficiently equivalent to another one of the natural language information; and outputting a justification based on the determining.

In yet a further embodiment, a computer readable medium comprises instructions for receiving natural language information at a first module; receiving lexical chains and axioms based on the natural language information and extended lexical information at the second module; and outputting a justification based on relative equivalence of the natural language information.

In yet another embodiment, a method for ranking answers to a natural language query, comprises receiving natural language information at a first module; receiving lexical chains and axioms based on the natural language information and extended lexical information at the second module; and outputting a justification based on at least one of an equivalence of the natural language information, the equivalence including: a strict equivalence, and a relaxed equivalence.

In yet a further embodiment, a computer readable medium comprises instructions for receiving natural language information at a first module; receiving lexical chains and axioms based on the natural language information and extended lexical information at the second module; and outputting a justification from a third module based on a relaxed equivalence of the natural language information.

### BRIEF DESCRIPTION OF THE DRAWINGS

FIG. 1a depicts a question answering system according to a preferred embodiment of the present invention;

FIG. 1b depicts a question answering system with logic prover according to a preferred embodiment of the present invention;

FIG. 2 depicts lexical chains according to a preferred embodiment of the present invention;

FIG. 3 depicts a Question Answering Engine according to a preferred embodiment of the present invention;

FIG. 4a depicts a logic prover according to a preferred embodiment of the present invention;

FIG. 4b depicts a logic form transformer according to a preferred embodiment of the present invention;

FIG. 4c depicts an axiom builder according to a preferred embodiment of the present invention;

FIG. 4d depicts a question logic form axioms according to a preferred embodiment of the present invention;

FIG. 4e depicts an answer logic forms axioms according to a preferred embodiment of the present invention;

FIG. 4f depicts an extended WordNet axiom according to a preferred embodiment of the present invention;

FIG. 4g depicts an NLP axioms according to a preferred embodiment of the present invention;

FIG. 4h depicts a lexical chain axiom according to a preferred embodiment of the present invention;

FIG. 4i depicts a justification according to a preferred embodiment of the present invention;

FIG. 4i′ depicts a justification with relaxation according to a preferred embodiment of the present invention;

FIG. 4i″ depicts a relaxation according to a preferred embodiment of the present invention; and

FIG. 4j depicts an answer re-ranking according to a preferred embodiment of the present invention.

### DETAILED DESCRIPTION OF THE INVENTION

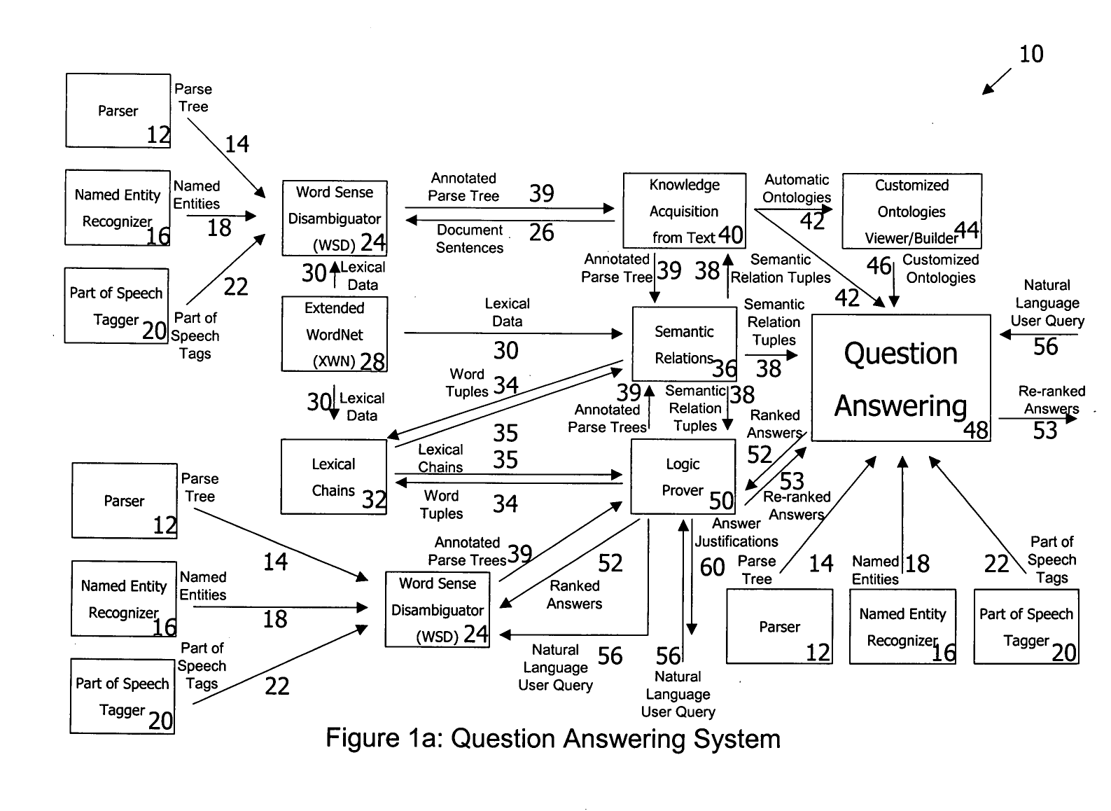

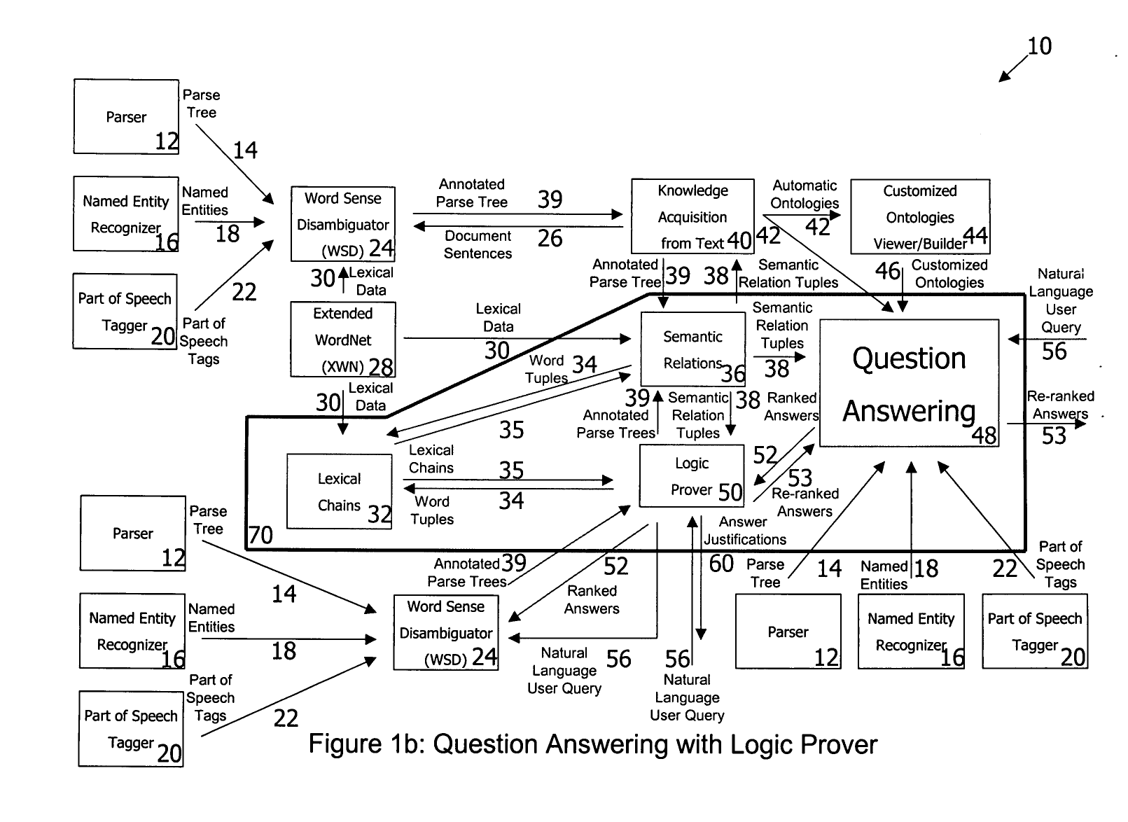

FIG. 1a depicts a question answering system 10 of the present invention. The system 10 includes a question answering module 48 that takes as input a natural language user query 56 which can consist of a question, a series of questions, or statements or series of statements requesting information.

The question answering module 48 relies on several modules in order to find candidate answers to the natural language user query. These include a parsing module 12 which outputs parse trees 14, a named entity recognizer 16 which outputs named entities 18, and a part of speech tagger 20, which outputs part of speech tags 22. An ontology building system outputs customized ontologies 46 and automatic ontologies 42. The ontology building system includes a customized ontology viewer/builder 44, which outputs the customized ontology 46, and takes as input automatically generated ontologies 42 which are output from a knowledge acquisition from text module 40.

The knowledge acquisition from text module 40 automatically creates ontologies from input text using the following modules: a semantic relations module 36 which takes from the knowledge acquisition from text module 40 an annotated parse tree 39 and returns semantic relation tuples 38. The annotated parse tree includes at least one of: a parse tree encapsulating sentence structure, words, word stems, part of speech tags, word senses and named entities. The knowledge acquisition from text module 40 passes document sentences 26 to and receives an annotated parse tree 39 from a word sense disambiguator module 24. The word sense disambiguator module 24 relies on the following modules: a syntactic parser 12 which outputs parse trees 14 to the word sense disambiguator 24, the named entity recognizer 16 which outputs named entities 18 to the word sense disambiguator module 24, the part of speech tagger 20 which outputs part of speech tags 22 to the word sense disambiguator module 24, and an extended WordNet module 28 that outputs lexical data to the word sense disambiguator module 24.

The semantic relations module 36 that supplies semantic relation tuples to the knowledge acquisition from text module 40 relies on the extended WordNet module 28 which outputs lexical data 30 to the semantic relations module 36. The semantic relations module 36 uses its input data to output word tuples 34 to a lexical chain module 32. The lexical chain module 32 takes the input word tuples 34 as well as lexical data 30 from the extended WordNet module 28. Based on the lexical data and the word tuples, the lexical chain module can determine and quantify the lexical similarity between the words in the word tuples. These relationships are returned as lexical chains 35 to the semantic relations module 36.

The question answering module 48 also receives from the semantic relations module 36 semantic relation tuples 38. Using all these inputs, the question answering module 48 produces a list of ranked answers that are related to the natural language user query 56. These answers are either passed back to the user as answers 53 or passed to the logic prover module 50 as ranked answers 52. The logic prover module 50 passes the ranked answers input 52 and the natural language user query 56 to the word sense disambiguator module 24. The word sense disambiguator module 24 uses these inputs as well as the syntactic parser 12, named entity recognizer 16 and part of speech tagger 20 to create and pass back annotated parse trees 39. The logic prover module 50 passes the annotated parse trees 39 to the semantic relations module 36 and receives back semantic relation tuples 38. In addition, the logic prover module 50 produces word tuples 34 which it passes to the lexical chains module 32. The lexical chains module 32 returns lexical chains 35 to the logic prover module 50. Using these inputs, the logic prover module 50 performs first order logic justification to arrive at a set of re-ranked answers 53 and their associated justifications 60. The answer justifications 60 are passed out of the logic prover module 50 to the user. The re-ranked answers 53 are passed out of the logic prover module to the question answering module 48 which passes them back to the user as re-ranked answers 53.

Referring now to FIG. 1b, the question answering system 10 with logic prover comprises: the question answering module 48, the semantic relation system 36, the logic prover system 50 and the lexical chain system 32.

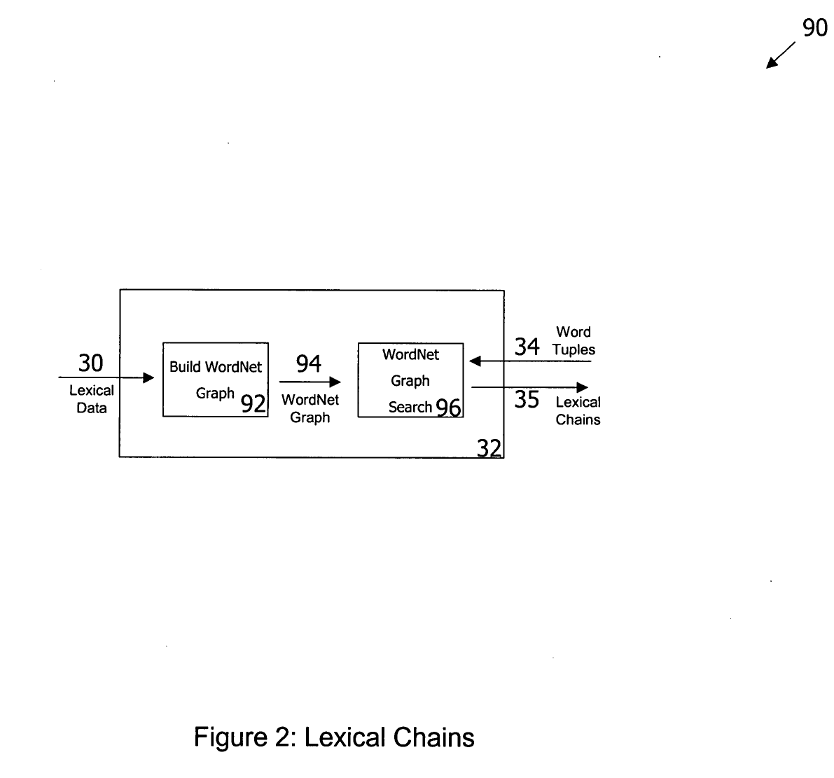

Referring now to FIG. 2, a lexical chains system 90 is depicted and includes the lexical chains module 32. The lexical chains module 32 receives lexical data 30 which is passed into an extended WordNet graph builder module 92 which builds an extended WordNet graph out of all the lexical data from extended WordNet. This extended WordNet graph is a weighted directed graph with nodes representing word/sense pairs from extended WordNet and edges representing the lexical relationships between word/sense pairs. The extended WordNet graph 94 is used as input to a extended WordNet graph search module 96. The extended WordNet graph search module 96 also takes as input word tuples 34 and proceeds to search the extended WordNet graph to try and find a path through the graph that goes through every node representing the input word tuples. If such a path is found, it is returned as output lexical chains 35 and represents a lexical relationship between all the input words in the word tuples.

In one embodiment of the present invention, a method for natural language question answering comprises receiving a question logic form, at least one answer logic form, and extended lexical information by a first module, outputting lexical chains to a second module, and utilizing axioms by the second module. The question logic form and the answer logic form are based on natural language. The method further comprises outputting at least one answer based on at least one previously ranked candidate answer associated with at least one of: the question logic form, the answer logic form, and the axioms, wherein the outputted answer includes at least one of: an exact answer, a phrase answer, a sentence answer, a multi-sentence answer, and wherein the question logic form is related to the answer logic form. The outputted answer can then be re-ranked based on the previously ranked candidate answer.

The method also comprises outputting at least one answer justification based on at least one candidate answer associated with at least one of: the question logic form, the answer logic form, and the axioms, wherein the outputted answer justification includes at least one of: every axiom used, question terms that unify with answer terms, predicate arguments dropped, predicates dropped, and answer extraction.

The utilized axioms are at least one of a following axiom from a group consisting of: lexical chain axioms, dynamic language axioms, and static axioms, wherein the lexical chain axioms are based on the lexical chains. The utilized lexical chain axioms and the utilized dynamic language axioms are created. The dynamic language axioms including at least one of: question logic form axioms, answer logic form axioms, question based natural language axioms, answer based natural language axioms, and dynamically selected extended lexical information axioms, and wherein the static axioms include at least one of: common natural language axioms, and statically selected extended lexical information axioms.

The method further comprises receiving semantic relation information by the second module, creating semantic relation axioms based on the semantic relation information, and outputting at least one answer based on at least one previously ranked candidate answer associated with at least one of: the question logic form, the answer logic form, the axioms, and the semantic relation axioms.

The system 10 of the present invention utilizes software or a computer readable medium that comprises instructions for receiving a question logic form based on a natural language user input query for information, at least one answer logic form, and extended lexical information by a first module, outputting lexical chains related to the extended lexical information to a second module, and utilizing axioms based on at least one of: the received lexical chains, existing axioms, and automatically created axioms, by the second module.

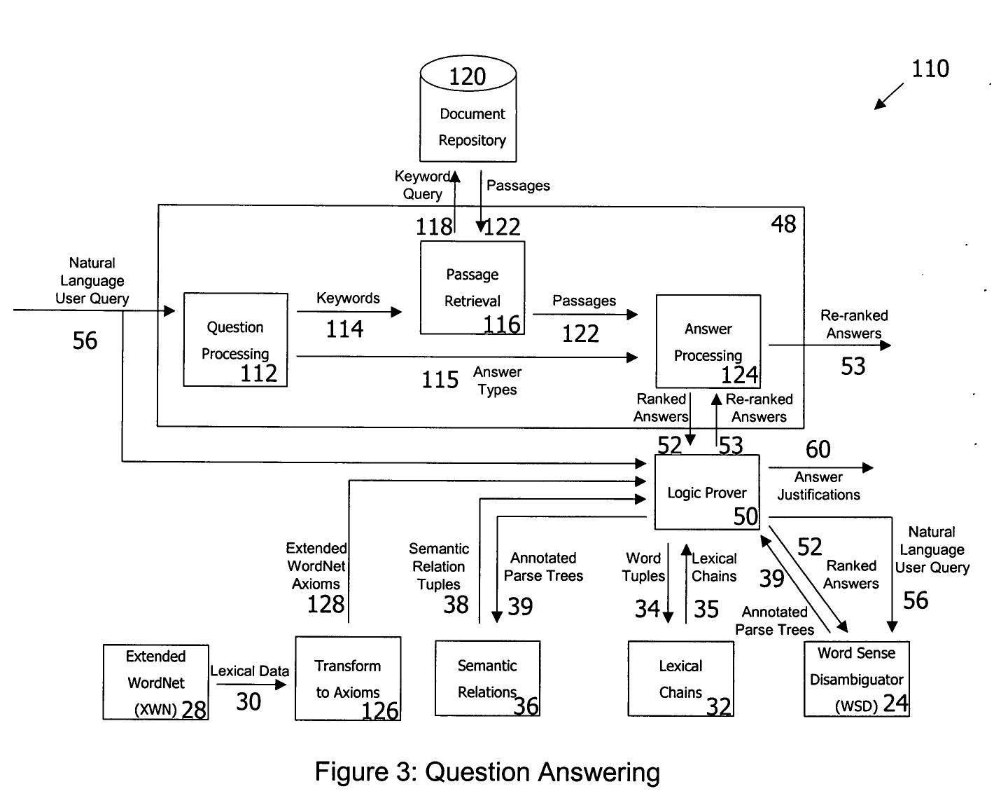

Referring now to FIG. 3, a question answering system 110 is depicted which includes the question answering module 48. The question answering module 48 takes as input a natural language user query 56 which goes into a question processing module 112, the question processing module 112 selects from the natural language user query select words that it considers important in order to answer the question. These are output as key words 114 from the question processing module. In addition, the question processing module 112 determines and outputs answer types 115. The key words 114 are passed into a passage retrieval module 116 which uses the key words to create a key word query which is output 118 to a document repository 120. The document repository contains documents in multiple formats that contain information the system will use to attempt to find answers. The document repository, based on the key word query, will return as output passages 122 to the passages retrieval module 116. These passages are related to the input query by having one or more key words or key word alternatives in them. These passages 122 are passed out from the passage retrieval module 116 to an answer processing module 124. The answer processing module 124 uses these passages 122 as well as the answer types, 115, to perform answer processing in an attempt to find exact, phrase, sentence and paragraph answers from the passages. The answer processing module 124 also ranks the answers it finds in the order it determines is the most accurate. These ranked answers are then passed out as output 52 to the logic prover module 50.

The logic prover module 50 takes as input the ranked answers 52, the natural language user query 56, and the extended WordNet axioms 128 from an extended WordNet axiom transformer 126 It passes the ranked answers 52 and natural language user query 56 to and receives annotated parse trees 39 from the word sense disambiguator module 24. Likewise, passes out word tuples 34 to the lexical chains module 32 and receives back lexical chains 35. Lastly, the logic prover module 50 passes the annotated parse trees 39 to and receives semantic relation tuples 38 from the semantic relations module 36. The logic prover module 50 then performs first order logic justification to produce the output answer justifications 60 and a re-ranking of the input ranked answers as output 53. These re-ranked answers are passed back to answer processing module 124 and returned out of the Question Answering Engine 48 as re-ranked answers 53.

In one embodiment of the present invention, a method for natural language question answering comprises receiving a user input query, receiving ranked answers related to the query, calculating a justification of the ranked answers, calculating a confidence of the ranked answers based on the justification, and outputting re-ranked answers based on the confidence. The method further comprises outputting the justification, outputting the confidence, and outputting new exact answers based on the justification, wherein the justification is based on at least one of: a question logic form, an answer logic form, and axioms.

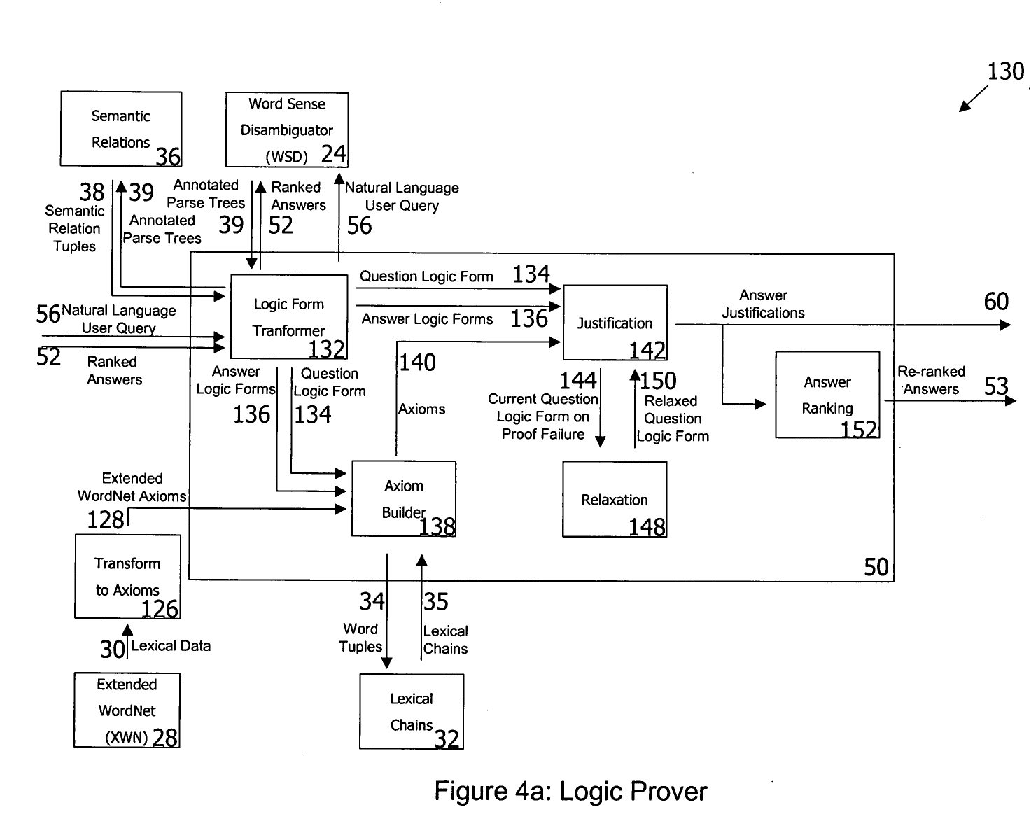

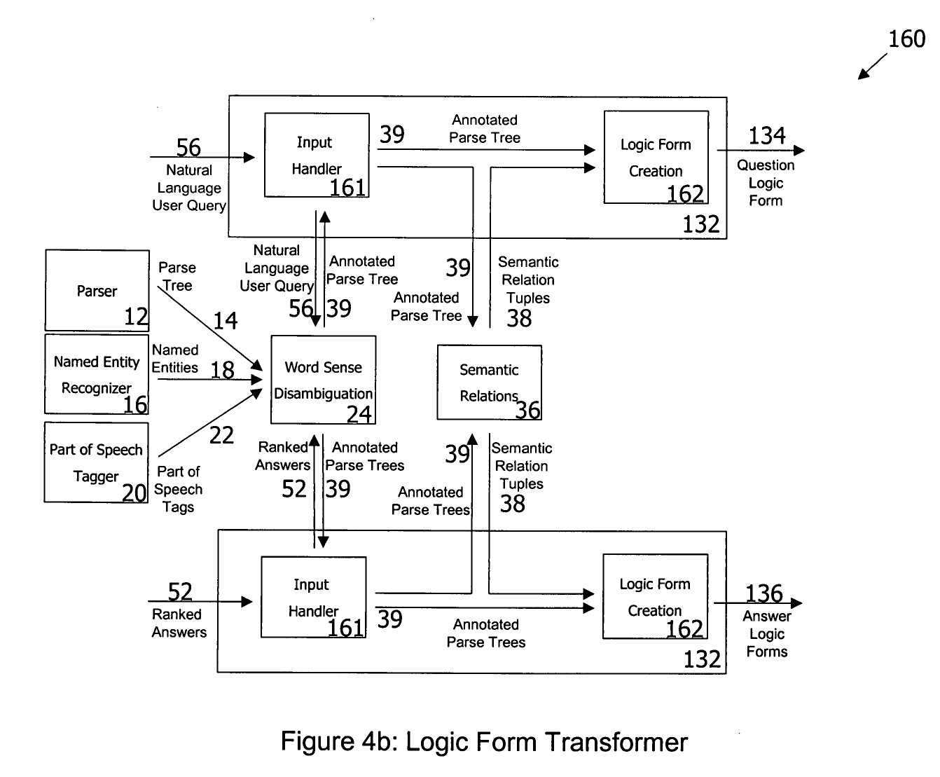

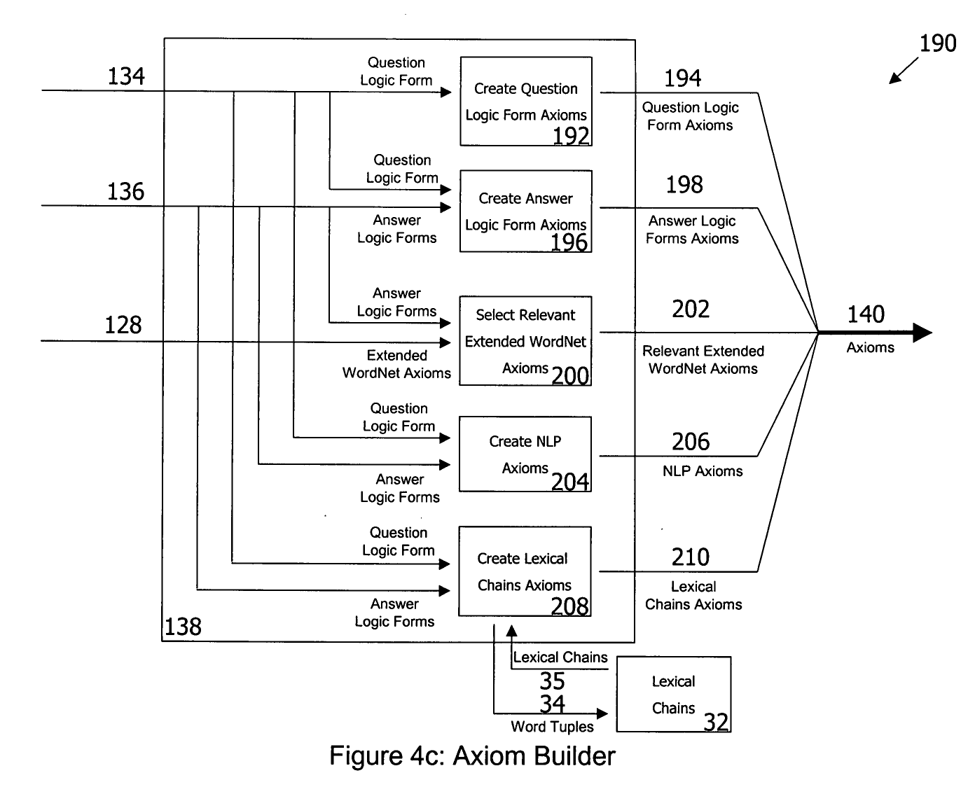

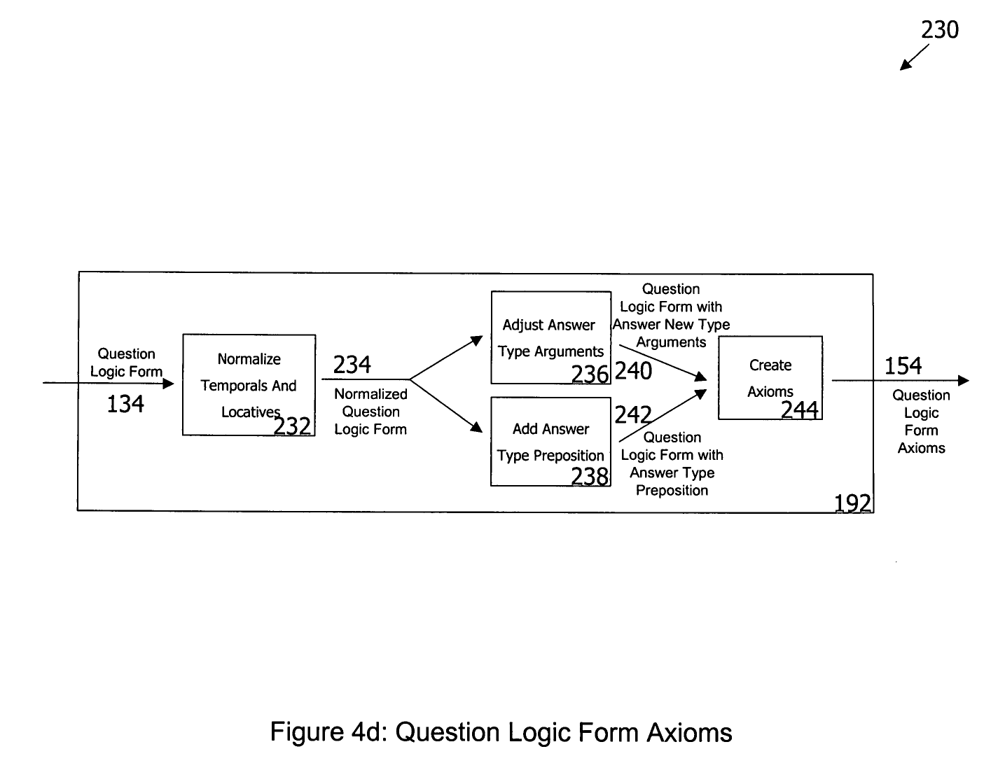

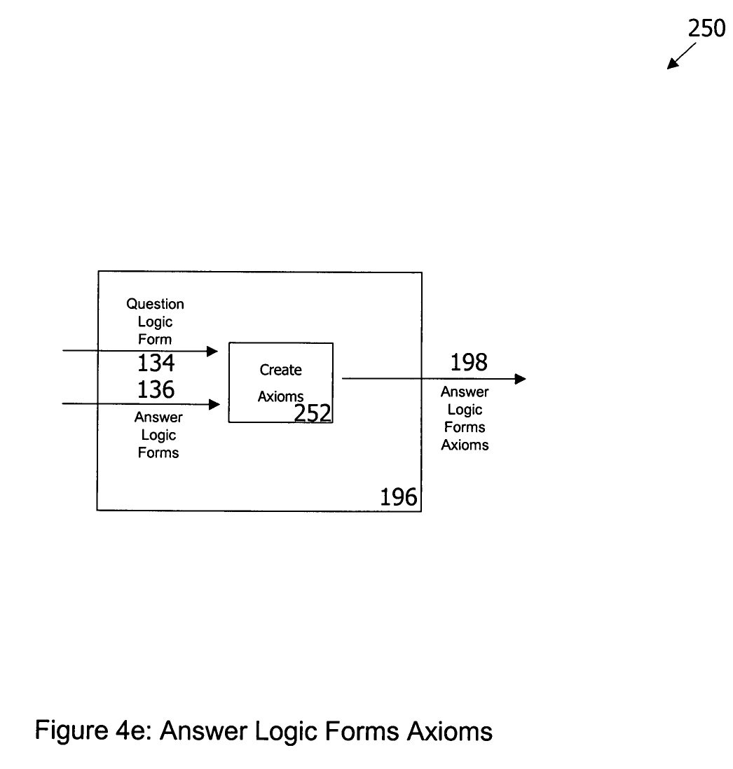

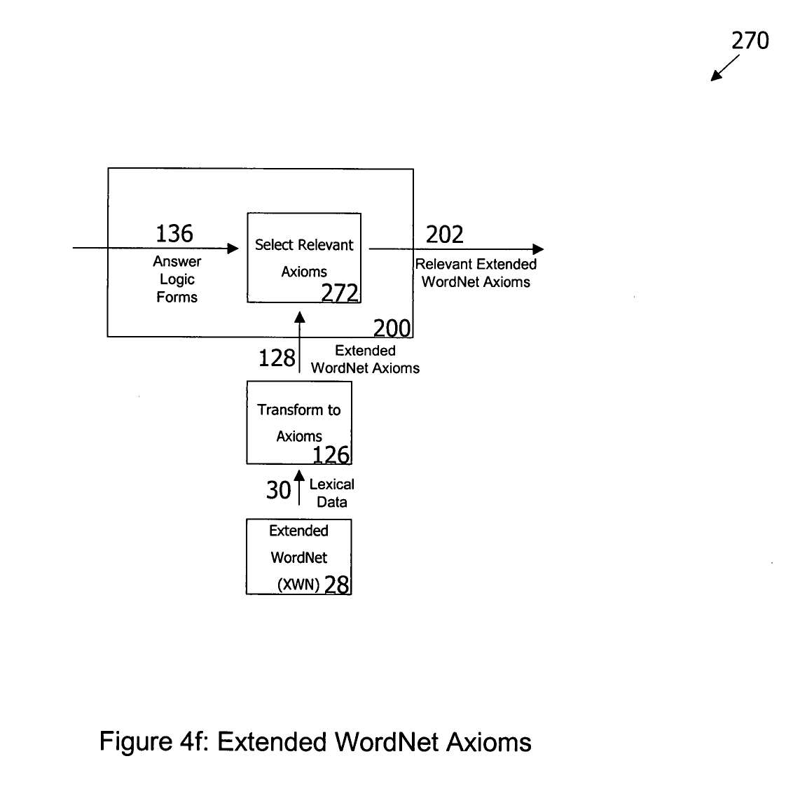

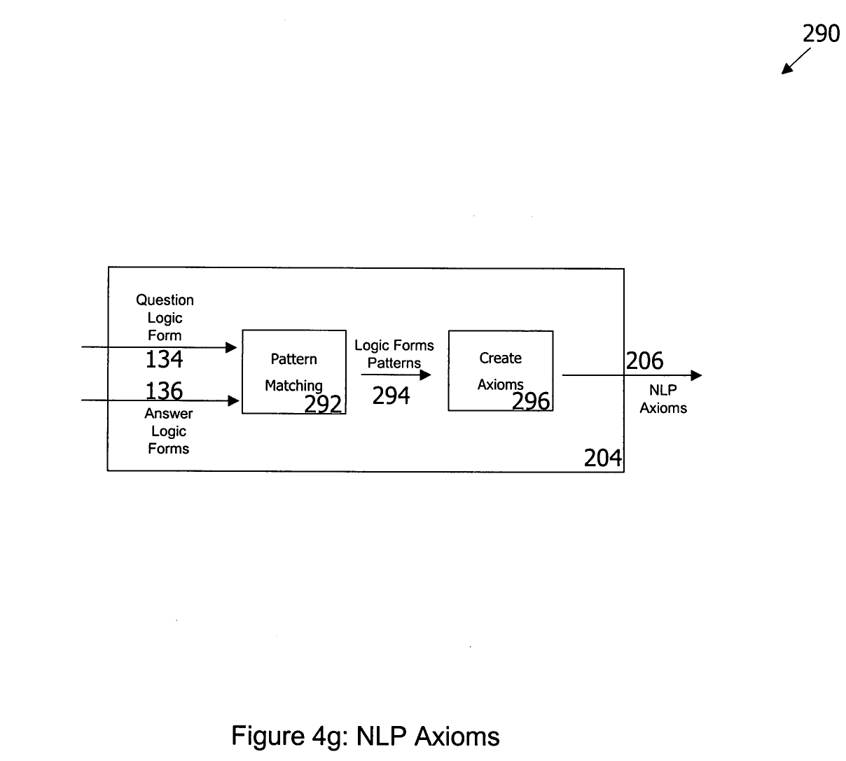

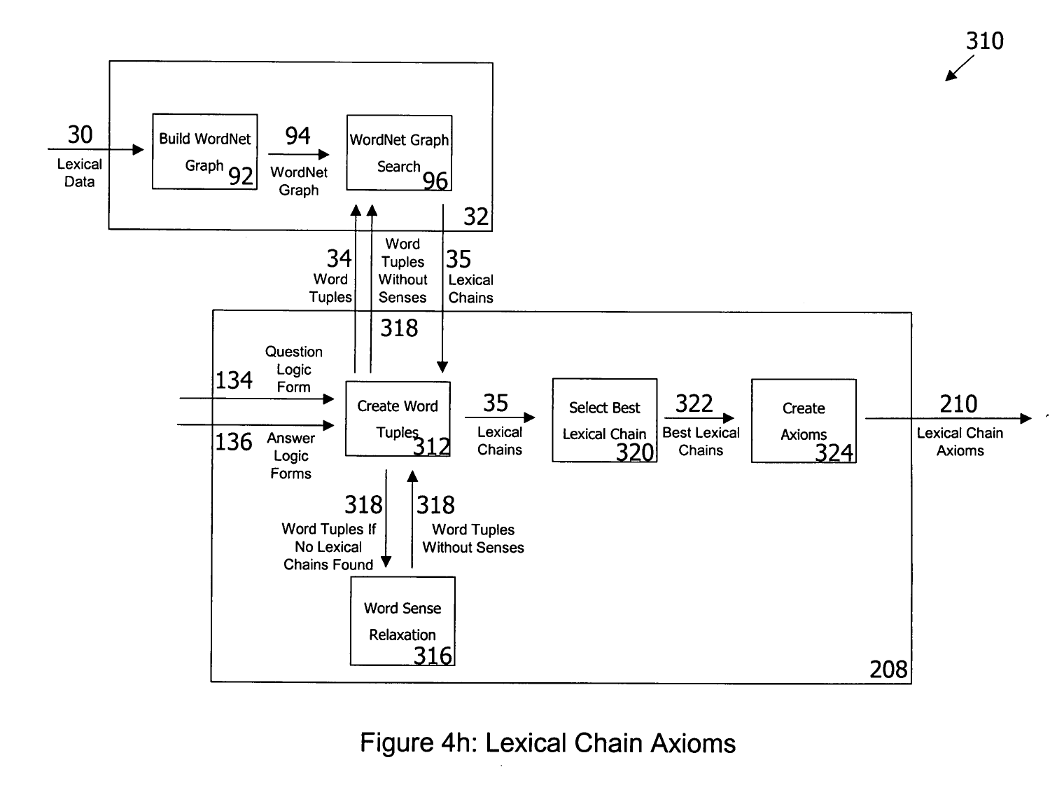

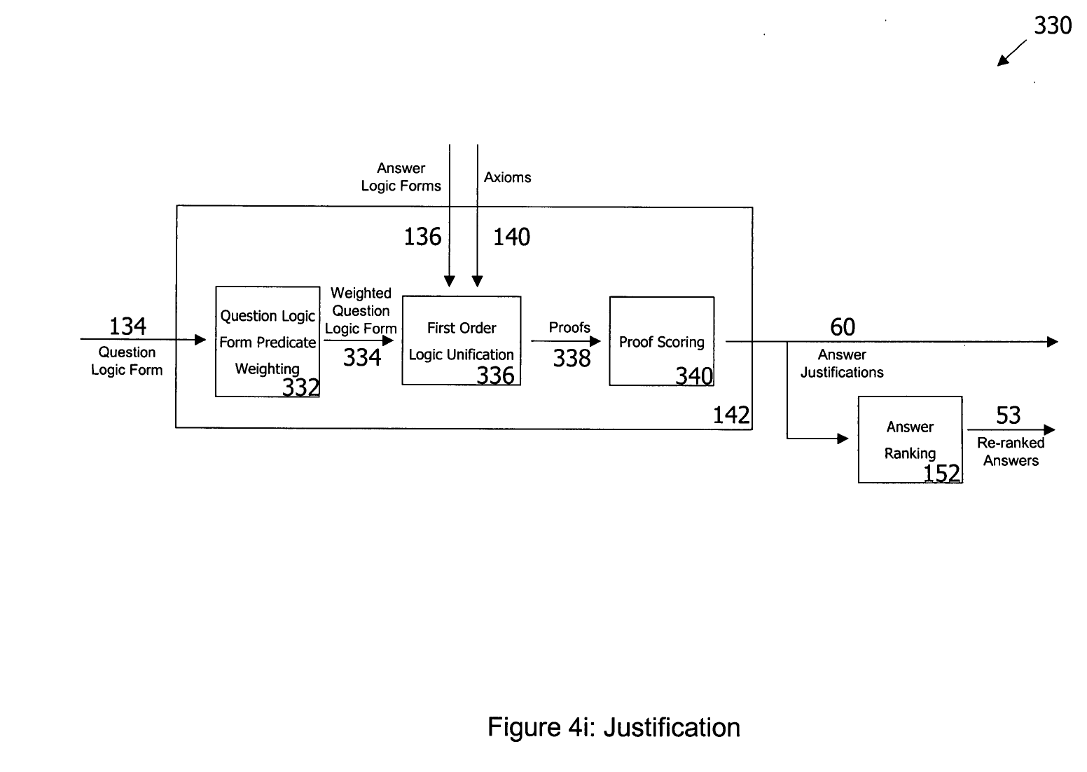

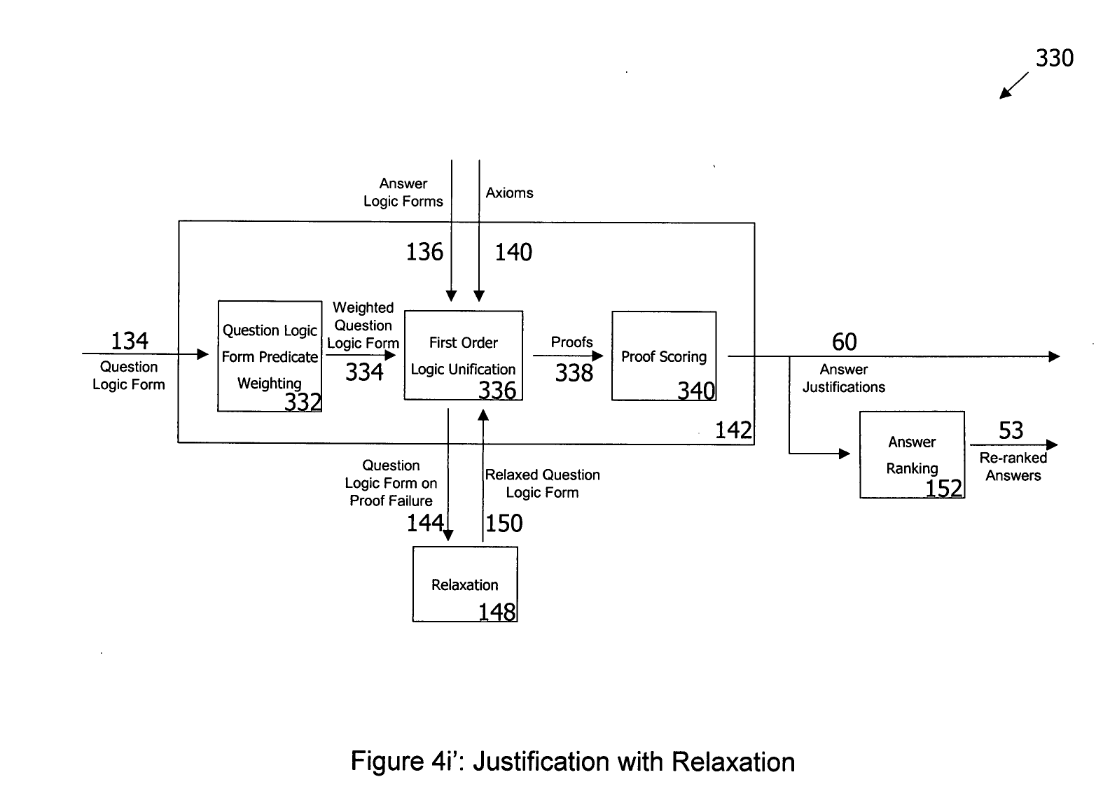

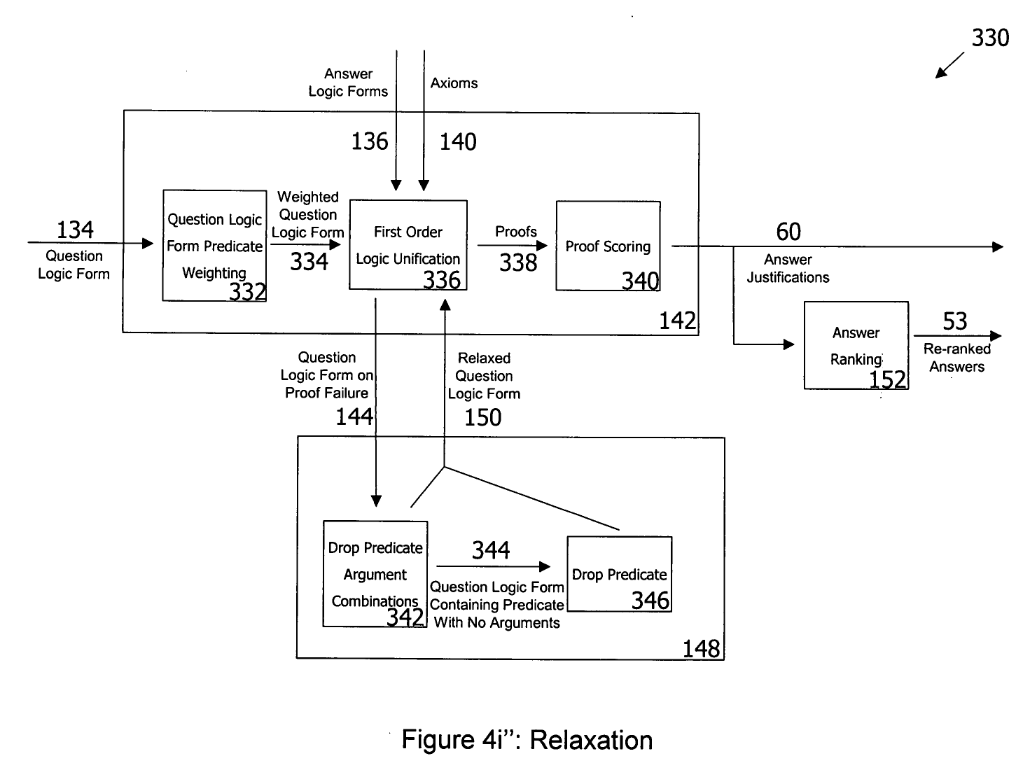

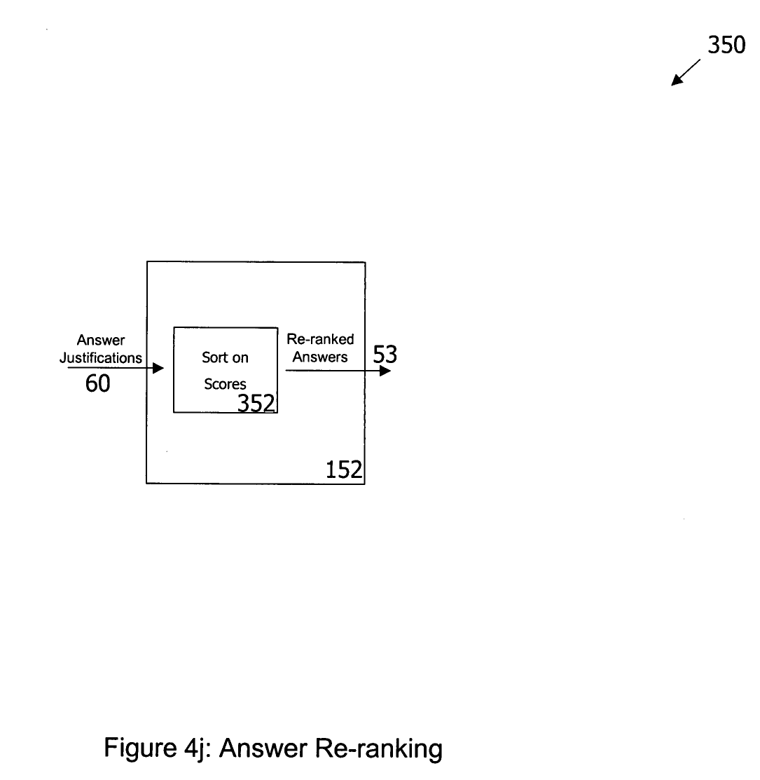

Referring now to FIG. 4a, a logic prover system 130 is presented which includes the logic prover module 50. The logic prover module 50 takes as input a natural language user query 56 and the ranked answers 52. These inputs are passed into a logic form transformer module 132. The logic form transformer 132 passes the ranked answers 52 and natural language user query 56 to and receives annotated parse trees 39 from the word sense disambiguator module 24. Likewise, it passes the annotated parse trees 39 to and receives semantic relation tuples 38 from the semantic relations module 36. Using these inputs, the logic form transformer module 132 transforms the natural language user query 56 and the ranked answers 52 into logic forms. These logic forms consist of question logic forms based on the natural language user query 56 and one or more answer logic forms based on each of the input ranked answers 52. The outputs from the logic form transformer 132 are answer logic forms 136 and question logic form 134. These outputs 136 and 134 are passed to an axiom builder module 138.

The axiom builder module 138 also takes as input extended WordNet axioms 128 which are created by an extended WordNet axiom module 126. This module 126 takes as input the lexical data 30 from the extended WordNet module 28. The axiom builder outputs word tuples 34 to a lexical chain module 32. The axiom builder module 138 receives from the lexical chain module 32 lexical chains as output 35. The axiom builder then creates axioms based on the logic forms, the lexical chains and the extended WordNet axioms. These axioms are output 140 to the justification module 142. The justification module 142 also takes as input the question logic form 134 and the answer logic forms 136 from the logic form transformer 132. The justification module 142 performs first order logic justification between the question logic form 134 and each answer logic form 136 using the axioms 140. If the justification module 142 is able to find a justification, this justification is passed out as output 60, answer justifications. However, if the justification module 142 is unable to unify the question logic form 134 with the answer logic form 136, it performs a relaxation procedure.

On a proof failure, the current question logic form is passed out as output 144 to a relaxation module 148. This relaxation module 148 relaxes the question logic form by removing arguments or predicates and passes this back to the justification module 142 as a relaxed question logic form 150. The justification module 142 will then re-perform the unification on the relaxed question logic form against the answer logic form in order to try and find an answer justification. This procedure continues until either an answer justification is found or the question logic form can be relaxed no more. The answer justifications are passed out from the justification module 132 to an answer ranking module 152. Based on the justification and the relaxation, the answer ranking module 152 re-ranks the ranked answers 52 from the most accurate to the least accurate answer as determined by the logic prover and outputs the re-ranked answers 53.

In one embodiment of the present invention, a method for ranking answers to a natural language query comprises receiving natural language information at a first module (such as the logic form transformer 132), outputting logic forms to a second module and to a third module (such as the axiom builder 138 and the justification module 142), receiving lexical chains and axioms based on extended lexical information at the second module, receiving selected ones of the axioms and other axioms at the third module, determining whether at least one of the natural language information is sufficiently equivalent to another one of the natural language information, and outputting a justification based on the determining.

The method further comprises, if the determination is insufficiently equivalent, outputting the at least one of the natural language information to a fourth module (such as the relaxation module 148), outputting a relaxed at least one of the natural language information to the third module, utilizing the relaxed natural language information to perform the determining, and receiving the justification at a fifth module (such as answer ranking module 152), wherein the justification is associated with a score. The re-ranked answers are then outputted based on the score.

The natural language information referenced above includes a user input query, ranked answers related to the query, and semantic relations related to the query and to the ranked answers; the logic forms are at least one question logic form and at least one answer logic form, and are based on the natural language information; the received lexical chains are based on word tuples related to the logic forms; the received axioms are static; the selected ones of the axioms are based on the at least one answer logic form; and the other axioms include at least one of: question logic form axioms, answer logic form axioms, natural language axioms, and lexical chain axioms.

The system 10 of the present invention utilizes software or a computer readable medium that comprises instructions for receiving natural language information at a first module, receiving lexical chains and axioms based on the natural language information and extended lexical information at the second module, and outputting a justification based on relative equivalence of the natural language information, wherein the extended lexical information determines a relationship between words in the natural language information.

Referring now to FIG. 4b, a logic form transformer system 160 is depicted which includes a logic form transformer module 132. The logic form transformation module 132 takes as input the natural language query 56 which gets passed to a input handler module 161. The input handler passes the natural language user query 56 to the word sense disambiguator 24 and receives in return an annotate parse tree 39. The annotated parse tree 39 is passed to the logic form creation module 162 as well as the semantic relations module 36, which passes the extracted semantic relation tuples 38 to the logic form creation module 162. The logic form creation module 162 uses the annotated parse tree 39 and semantic relation tuples 38 to create a question logic form 134 and passes it out of the logic form transformer 132. Question logic forms consists of predicates based on the input natural language user query 56 containing the words, named entities, parts of speech, word senses, and arguments representing the sentence structure.

The logic form transformer module 132 also takes as input ranked answers 52 which are passed to an input handler module 161. The input handler module 161 passes the ranked answers 52 to the word sense disambiguator 24 and receives in return annotate parse trees 39. The annotated parse trees 39 are passed to the logic form creation module 162 as well as the semantic relations module 36, which passes the extracted semantic relation tuples 38 to the logic form creation module 162. The logic form creation module 162 uses the annotated parse trees 39 and semantic relation tuples 38 to create answer logic forms 136 and pass them out of the logic form transformer 132. Answer logic forms consists of predicates based on the input ranked answers 52 containing the words, named entities, parts of speech, word senses, and arguments representing the sentence structure.

Referring now to FIG. 4c, a axiom builder system 190 is presented which includes the axiom builder module 138. The axiom builder module 138 takes as input the question logic form 134, the answer logic form 136 and the extended WordNet axioms 128. The axiom builder module 138 is made up of several sub modules for creating specific axioms. The first such module is the question logic form axiom builder 192 which takes as its input the question logic form 134. The question logic form axiom builder 192 creates axioms based on the question logic form and outputs them as question logic form axioms 194. The second sub module is the answer logic form axiom builder 196 which takes as input the question logic form 134 and the answer logic forms 136. Based on these inputs, the answer logic form axiom builder 196 creates answer logic form axioms which are output as output 198. The third sub module is the relevant extended WordNet axiom builder 200 which takes as input the answer logic forms 136 and the extended WordNet axioms 128. The relevant extended WordNet axiom builder 200 uses the answer logic forms to select relevant extended WordNet axioms. These are output as relevant extended WordNet axioms output 202.

The next module is the NLP axiom builder 204 which takes as input the question logic form 134 and the answer logic forms 136. The NLP axiom builder module 204 uses the question logic form and answer logic forms to create natural language processing axioms which are output 206. The last sub module, the lexical chain axiom builder 208 takes as input the question logic form 134 and the answer logic forms 136. It produces word tuples 34 which are passed to the lexical chain module 32. The lexical chain module 32 passes back lexical chains 35 to the lexical chain axiom builder 208. Using this data, the lexical chain axiom builder 208 produces lexical chain axioms 210. These axioms, question logic form axioms 194, answer logic form axioms 198, relevant extended WordNet axioms 202, NLP axioms 206 and lexical chain axioms 210 are represented by the output axioms 140.

Referring now to FIG. 4d, a question logic form axioms system 230 is presented which includes the question logic form axiom builder module 192. The question logic form axiom builder module 192 takes the question logic form 134 as input to the normalize temporal and locatives module 232. This module normalizes the temporal and location portions of the question logic form to produce normalized question logic form output 234. The normalized question logic form output 234 needs to have its answer type predicate modified, is done in one of two ways. The first way is to pass the normalized question logic form 234 into and adjust answer type arguments module 236. The output of adjust answer type arguments module 236 is a question logic form with new answer type arguments 240. The other possibility is to pass the normalized question logic form 234 into an answer type preposition module 238. The answer type preposition module 238 creates an extra prepositional predicate linking it to the answer type predicate. The output from the answer type preposition module 238 is a question logic form with an extra answer type preposition form 242. The question logic form with new answer type arguments 240 or the question logic form answer type with extra preposition predicate 242 are input for the create axioms module 244. The create axiom module 244 uses the normalized question logic form with the modified answer type predicate to create the axioms. The output from the create axioms module 244 are the question logic form axioms 154.

Referring now to FIG. 4e, answer logic forms axiom system 250 is depicted which includes answer logic form axiom builder module 196. The answer logic form axiom builder module 196 takes as input question logic form 134 and the answer logic forms 136. These are passed to a create axioms module 252 which based on the question logic form and the associated answer logic form creates the answer logic forms axioms 198. The answer logic forms axioms 198 are passed as output from the create axiom module 252 out of the answer logic form axiom module 196.

Referring now to FIG. 4f, an extended WordNet axioms system 270 is presented which includes the WordNet axiom builder module 200. The extended WordNet axiom builder module 200 takes as input the answer logic forms 136 and the extended WordNet axioms 128. The extended WordNet axioms 128 are created by a transform extended WordNet axioms module 126 which takes as input the lexical data 30 from the extended WordNet module 28. The extended WordNet axioms 128 and the answer logic forms 136 are input to a select relevant axioms module 272. Based on the answer logic forms, a select relevant axioms module 272 selects the relevant extended WordNet axioms from the input extended WordNet axioms 128. The relevant extended WordNet axioms are passed out as output 202.

Referring now to FIG. 4g, an NLP axioms system 290 is presented which includes the NLP axiom builder module 204. The NLP axiom builder module 204 takes as input the question logic form 134 and the answer logic forms 136 as input into a pattern matching module 292. The pattern matching module searches for patterns between the question logic form 134 and the answer logic forms 136 to produce logic form patterns 294. These logic form patterns 294 are passed out of the pattern matching module 292 and into a create axiom module 296. The create axiom module 296 uses these patterns to create NLP axioms which are passed out as output 206, NLP Axioms.

Referring now to FIG. 4h, a lexical chain axiom system 310 is presented which includes the lexical chain axiom builder module 208. The lexical chain axiom builder module 208 takes as input the question logic form 134 and the answer logic forms 136 into a create word tuples module 312. The create word tuples module 312 selects combinations of question logic form and answer logic form words to create word tuples 34 which are passed out of the create word tuples module 312 and into the lexical chain module 32. The lexical chain module returns as output lexical chains 35 which are input to the create word tuples module 312. If the lexical chain module 32 was unable to find any relevant lexical chains based on the input word tuples, the create word tuples module 312 passes the word tuples 34 to a remove sense relaxation module 316.

The remove sense relaxation module 316 removes the word sense from the word tuples and passes back word tuples without word senses 318 to the create word tuples module 312. The create word tuples module 312 then passes the word tuples without senses to the lexical chain module 32 to perform a relaxed lexical chain search. The relaxed lexical chain search uses the same WordNet graph search algorithm except that word senses are ignored. The resulting lexical chains are passed back as output 35 to the create word tuples module 312. The relevant lexical chains 35, if any, are then passed from the create word tuples module 312 to the select best lexical chain module 320. The select best lexical chain module 320 then uses the lexical chain scores based on the weights and the extended WordNet graph to select the most relevant, highest scoring lexical chain for each relevant word tuple. The select best lexical chain module 320 then outputs the best lexical chains 322 to a create axioms module 324. The create axioms module 324 uses the lexical chains to build lexical chain axioms which are passed as output 210.

Referring now to FIG. 4i, a justification system 330 is presented which includes the justification module 142. The justification module 142 takes as input the question logic form 134 which is passed into a question logic form predicate weighting module 332. The question logic form weighting module weights the individual predicates from the question logic form and passes them on as weighted question logic form 334 to a first order logic unification module 336. The justification module 142 also takes as input answer logic forms 136 and axioms 140 which are passed into the first order logic unification module 336. The first order logic unification module 336 then performs first order logic unification using the input axioms 140 to produce justifications (proofs) between the question logic form and the answer logic forms. These proofs are passed as output 338 from the first order logic unification module 336 into a proof scoring module 340.

The proof scoring module 340 scores each proof based on which axioms were used to arrive at the unification. The proof scoring module 340 then passes this answer justification 60 out of the logic prover justification module 142 as output. The answer justification 60 is also passed as input to an answer ranking module 152 which based on the answer justifications, which include proof scores, does answer re-ranking to arrive at a re-ranked order for the input answers which is passed as out as re-ranked answers 53.

Referring now to FIG. 4i′, the justification system 330 is shown with a relaxation module 148. The first order logic unification module 336 interfaces with a relaxation module 148 when performing a first order logic unification. If it is unable to find a justification between the question logic form and an answer logic form, the question logic form is passed as output 144 to the relaxation module 148. The relaxation module 148 then performs relaxation on the question logic form which is passes back as output 150 to the first order logic unification module 336. The first order logic unification module 336 then re-performs the first order logic justification using the relaxed logic form and the original answer logic form. If no proof is found, then the relaxation is performed again to relax the question logic form further. This process continues until either a proof is found or the question logic form can be relaxed no more.

Referring now to FIG. 4i″, the justification system 330 is presented with relaxation module 148 and relaxation sub-modules 342 and 346. To perform relaxation, the relaxation module 148 takes as input from first order logic unification module 336 the question logic form 144 which is passed to the drop predicate argument combination module 342. The drop predicate argument combination module 342 then drops predicate argument combinations and passes the relaxed question logic form 150 to the first order logic unification module 336. If a predicate has already had all its arguments dropped, then the drop predicate argument combination module 342 passes that question logic form 344 to a drop predicate module 346. The drop predicate module 346 drops the entire predicate and passes the resulting relaxed logic form 150 to the first order logic unification module 336, which performs the unification procedure once again. This process continues until either a proof is found, or the drop predicate module 346 drops the answer type predicate. If the answer type predicate is dropped, then the justification indicates no proof was found. The proof scoring module 340 scores each proof based on which axioms were used to arrive at the unification and which arguments and predicates were dropped if a relaxed question logic form was used. Justifications that indicate no proof was found are given the minimum score of 0.

Referring now to FIG. 4j, an answer ranking module 350 is shown. The answer ranking module takes the answer justifications 60 as input and passes them into a sort on scores module 352. A sort on scores module 352 re-ranks the answers based on the scores from the input answer justifications to arrive at a re-ranked list of answers which is output 53.

In one embodiment of the present invention, a method for ranking answers to a natural language query comprises receiving natural language information at a first module, receiving lexical chains and axioms based on the natural language information and extended lexical information at the second module, and outputting a justification based on at least one of an equivalence of the natural language information, the equivalence including: a strict equivalence, and a relaxed equivalence.

The system 10 of the present invention utilizes software or a computer readable medium that comprises instructions for receiving natural language information at a first module, receiving lexical chains and axioms based on the natural language information and extended lexical information at the second module, and outputting a justification from a third module based on a relaxed equivalence of the natural language information, wherein the natural language information is represented as predicates with arguments. The computer readable medium of further comprises marking arguments to be ignored at the third module, marking predicates to be ignored at the third module, outputting an empty justification if no unmarked predicates remain, and outputting an empty justification if all answer type predicates are dropped, wherein the answer type predicates are at least one of the predicates.

Although an exemplary embodiment of the system and method of the present invention has been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims. For example, the capabilities of the natural language question answering system 10 can be performed by one or more modules in a distributed architecture and on or via any electronic device.

The present invention further benefits from utilizing automatically generated ontologies to allow the logic prover to reason and draw inferences about domain-specific concepts and ideas. Doing so involves using the domain-specific ontologies to automatically produce axioms which could be used by the logic prover's justification module to improve the question answering system's text understanding.

In order to improve performance and scalability, a distributed natural language question answering system utilizing a logic prover is utilized. This would involve efficiently distributing candidate answers to multiple machines in order to create the dynamic axioms and perform the justification. Merging unified candidate answers for re-ranking is also a significant step in the distributed process.

Also, utilizing deeper semantic understanding within the logic prover subsystem provides more accurate and precise answers. Adding semantic data to logic forms as well as developing modules to handle specific, critically important semantic concepts significantly improves the present invention. In addition, this would allow the logic prover to perform semantic reasoning by creating specific semantic relation axioms and predicates which allow the justification and relaxation module to determine temporal, spatial, and kinship relationships, just to name a few. In addition, embedding semantic information by expanding the logic form representation to support epistemic logic modal operators allows the logic prover subsystem to reason over negations, quantifications, conditionals and statements of belief, thereby expanding the system's semantic understanding.

Further, improving the logic prover's justification and relaxation modules involves developing multiple, dynamically selected reasoning strategies. Using partition-based reasoning on extended WordNet, the logic prover's execution time and accuracy is greatly enhanced. In addition, utilizing forward message passing allows the logic prover to dynamically adjust the reasoning strategy based on runtime statistics and data, thereby allowing intelligent, real-time resource allocation. By utilizing these techniques to improve the logic prover, the overall accuracy and efficiency of the present invention is improved.

1. A method for natural language question answering, comprising:
receiving a question logic form, at least one answer logic form, and extended lexical information by a first module;
outputting lexical chains to a second module; and
utilizing axioms by the second module.

2. The method of claim 1 comprising outputting at least one answer based on at least one previously ranked candidate answer associated with at least one of: the question logic form, the answer logic form, and the axioms.

3. The method of claim 2, wherein the outputted answer includes at least one of: an exact answer, a phrase answer, a sentence answer, a multi-sentence answer.

4. The method of claim 3 comprising re-ranking the outputted answer based on the previously ranked candidate answer.

5. The method of claim 1 comprising outputting at least one answer justification based on at least one candidate answer associated with at least one of: the question logic form, the answer logic form, and the axioms.

6. The method of claim 5, wherein the outputted answer justification includes at least one of: every axiom used, question terms that unify with answer terms, predicate arguments dropped, predicates dropped, and answer extraction.

7. The method of claim 1, wherein the question logic form is related to the answer logic form.

8. The method of claim 1, wherein the utilized axioms are at least one of a following axiom from a group consisting of:
lexical chain axioms;
dynamic language axioms; and
static axioms.

9. The method of claim 8, wherein the lexical chain axioms are based on the lexical chains.

10. The method of claim 8 comprising creating the utilized lexical chain axioms.

11. The method of claim 8 comprising creating the utilized dynamic language axioms.

12. The method of claim 8, wherein the dynamic language axioms include at least one of: question logic form axioms, answer logic form axioms, question based natural language axioms, answer based natural language axioms, and dynamically selected extended lexical information axioms.

13. The method of claim 8, wherein the static axioms include at least one of: common natural language axioms, and statically selected extended lexical information axioms.

14. The method of claim 1, wherein the question logic form is based on natural language.

15. The method of claim 1, wherein the answer logic form is based on natural language.

16. The method of claim 1 comprising receiving semantic relation information by the second module.

17. The method of claim 16 comprising creating semantic relation axioms based on the semantic relation information.

18. The method of claim 17 comprising outputting at least one answer based on at least one previously ranked candidate answer associated with at least one of: the question logic form, the answer logic form, the axioms, and the semantic relation axioms.

19. A computer readable medium comprising instructions for:
receiving a question logic form based on a natural language user input query for information, at least one answer logic form, and extended lexical information by a first module;
outputting lexical chains related to the extended lexical information to a second module; and
utilizing axioms based on at least one of: the received lexical chains, existing axioms, and automatically created axioms, by the second module.

20. A method for natural language question answering, comprising:
receiving a user input query;
receiving ranked answers related to the query;
calculating a justification of the ranked answers;
calculating a confidence of the ranked answers based on the justification; and
outputting re-ranked answers based on the confidence.

21. The method of claim 20 comprising outputting the justification.

22. The method of claim 20 comprising outputting the confidence.

23. The method of claim 20, wherein the justification is based on at least one of: a question logic form, an answer logic form, and axioms.

24. The method of claim 20 comprising outputting new exact answers based on the justification.

25. A method for ranking answers to a natural language query, comprising:
receiving natural language information at a first module;
outputting logic forms to a second module and to a third module;
receiving lexical chains and axioms based on extended lexical information at the second module;
receiving selected ones of the axioms and other axioms at the third module;
determining whether at least one of the natural language information is sufficiently equivalent to another one of the natural language information; and
outputting a justification based on the determining.

26. The method of claim 25 comprising if the determination is insufficiently equivalent, outputting the at least one of the natural language information to a fourth module.

27. The method of claim 26 comprising outputting a relaxed at least one of the natural language information to the third module.

28. The method of claim 27 comprising utilizing the relaxed natural language information to perform the determining.

29. The method of claim 25 comprising receiving the justification at a fifth module.

30. The method of claim 29, wherein the justification is associated with a score.

31. The method of claim 30 comprising outputting re-ranked answers based on the score.

32. The method of claim 25, wherein the natural language information includes a user input query.

33. The method of claim 25, wherein the natural language information includes ranked answers related to the query.

34. The method of claim 25, wherein the natural language information includes semantic relations related to the query and to the ranked answers.

35. The method of claim 25, wherein the logic forms are at least one question logic form and at least one answer logic form.

36. The method of claim 25, wherein the logic forms are based on the natural language information.

37. The method of claim 25, wherein the received lexical chains are based on word tuples related to the logic forms.

38. The method of claim 25, wherein the received axioms are static.

39. The method of claim 35, wherein the selected ones of the axioms are based on the at least one answer logic form.

40. The method of claim 25, wherein the other axioms include at least one of: question logic form axioms, answer logic form axioms, natural language axioms, and lexical chain axioms.

41. A computer readable medium comprising instructions for:
receiving natural language information at a first module;
receiving lexical chains and axioms based on the natural language information and extended lexical information at the second module; and
outputting a justification based on relative equivalence of the natural language information.

42. The method of claim 41, wherein the extended lexical information determines a relationship between words in the natural language information.

43. A method for ranking answers to a natural language query, comprising:
receiving natural language information at a first module;
receiving lexical chains and axioms based on the natural language information and extended lexical information at the second module; and
outputting a justification based on at least one of an equivalence of the natural language information, the equivalence including: a strict equivalence, and a relaxed equivalence.

44. A computer readable medium comprising instructions for:
receiving natural language information at a first module;
receiving lexical chains and axioms based on the natural language information and extended lexical information at the second module; and
outputting a justification from a third module based on a relaxed equivalence of the natural language information.

45. The computer readable medium of claim 44, wherein the natural language information is represented as predicates with arguments.

46. The computer readable medium of claim 45 comprising marking arguments to be ignored at the third module.

47. The computer readable medium of claim 46 comprising marking predicates to be ignored at the third module.

48. The computer readable medium of claim 47 comprising outputting an empty justification if no unmarked predicates remain.

49. The computer readable medium of claim 47 comprising outputting an empty justification if all answer type predicates are dropped, wherein the answer type predicates are at least one of the predicates.
